(19) United States
(12) Patent Application Publication
(10) Pub. No.: US 2026/0147517 A1
(43) Pub. Date: May 28, 2026

(54) CONTROL METHOD FOR INFORMATION PROCESSING DEVICE, DISPLAY SYSTEM, AND NON-TRANSITORY COMPUTER READABLE STORAGE MEDIUM STORING PROGRAM

(71) Applicant: SEIKO EPSON CORPORATION, Tokyo (JP)

(72) Inventor: Kensuke KIDA, MATSUMOTO-SHI (JP)

(21) Appl. No.: 19/400,716

(22) Filed: Nov. 25, 2025

(30) Foreign Application Priority Data
Nov. 28, 2024 (JP) 2024-207466

(51) Int. Cl. G06F 3/14; G06F 3/0482; H04W 84/18

(52) U.S. Cl. CPC G06F 3/14; G06F 3/0482; H04W 84/18

(57) ABSTRACT

A control method for an information processing device connected to an infrastructure network, the control method including receiving an operation of requesting connection with a first display device that is not connected to the infrastructure network; notifying that the connection with the infrastructure network is to be disconnected; receiving an operation of approving disconnection from the infrastructure network; and the information processing device is connected to the first display device via an ad-hoc network as a display device to which image data is transmitted.

The present application is based on, and claims priority from, JP Application Serial Number 2024-207466, filed Nov. 28, 2024, the disclosure of which is hereby incorporated by reference herein in its entirety.

### BACKGROUND

### 1. Technical Field

The present disclosure relates to a control method for an information processing device, a display system, and a program.

### 2. Related Art

In the related art, a technique for connecting a display device and an information processing device via an infrastructure network is known. For example, JP-A-2012-191411 discloses a PC that acquires an SSID from a projector via an ad-hoc network and connects to the projector via an infrastructure network based on the acquired SSID.

However, when an information processing device such as the PC described in JP-A-2012-191411 is connected, via the ad-hoc network, to a display device that is not connected to the infrastructure network, the connection to the infrastructure network is disconnected. Therefore, the information processing device of the related art may connect to the display device via the ad-hoc network without a user grasping that the connection to the infrastructure network is to be disconnected.

### SUMMARY

A control method for an information processing device according to the present disclosure is a control method for the information processing device connected to an infrastructure network, the control method including receiving an operation of requesting connection with a first display device that is not connected to the infrastructure network; when the operation of requesting connection is received, notifying that connection with the infrastructure network is to be disconnected; receiving an operation of approving disconnection from the infrastructure network; and when the operation of approving is received, connecting, via an ad-hoc network, the information processing device to the first display device as a display device to which image data is to be transmitted.

A display system according to the present disclosure includes a first display device that is not connected to an infrastructure network and an information processing device connected to the infrastructure network, wherein the information processing device receives an operation for requesting connection with the first display device, notifies that connection with the infrastructure network is to be disconnected when the operation of requesting connection is received, receives an operation of approving disconnection from the infrastructure network, and when the operation of approving is received, connects, via an ad-hoc network, the information processing device to the first display device as a display device to which the image data is to be transmitted.

A non-transitory computer-readable storage medium storing a program of the present disclosure, the program causes a processor of an information processing device connected to an infrastructure network to receive an operation for requesting connection with a first display device that is not connected to the infrastructure network, notify that connection with the infrastructure network is to be disconnected when the operation of requesting connection is received, receive an operation of approving disconnection from the infrastructure network, and when the operation of approving is received, connect, via an ad-hoc network, the information processing device to the first display device as a display device to which image data is to be transmitted.

### BRIEF DESCRIPTION OF THE DRAWINGS

FIG. 1 is a diagram illustrating a configuration of a projection system.

FIG. 2 is a block diagram illustrating a configuration of a projector.

FIG. 3 is a block diagram illustrating a configuration of an information processing device.

FIG. 4 is a diagram illustrating an example of a list.

FIG. 5 is a diagram illustrating an example of a notification screen.

FIG. 6 is a flowchart illustrating an operation of the information processing device.

### DESCRIPTION OF EMBODIMENTS

### 1. Configuration of Projection System

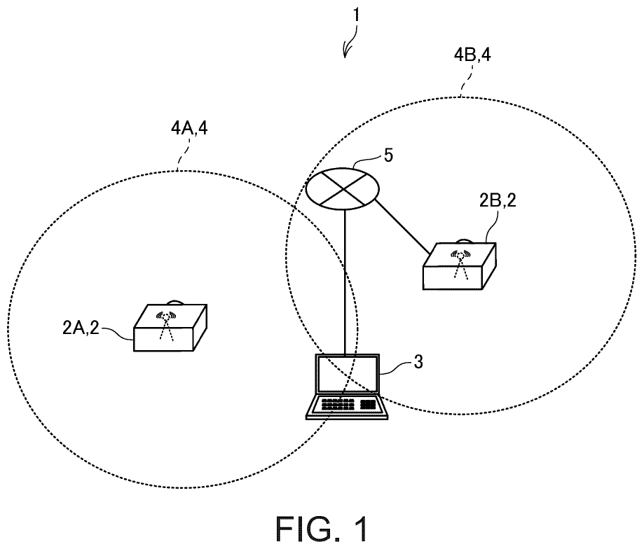

FIG. 1 is a diagram showing configuration of a projection system 1.

The projection system 1 includes a projector 2 and an information processing device 3.

The projection system 1 is an example of a “display system”. The projector 2 is an example of a “display device”.

The projector 2 receives image data from the information processing device 3 and generates image light based on the image represented by the received image data. The projector 2 projects the image by emitting the generated image light to a projection surface. Note that examples of the projection surface on which the projector 2 projects the image include a curtain-like screen and a wall surface of a building.

The information processing device 3 transmits the image data of the image to be projected by the projector 2 to the projector 2, and corrects the shape of the image to be projected by the projector 2. The information processing device 3 illustrated in FIG. 1 is a notebook type Personal Computer (PC). Note that the information processing device 3 is not limited to a notebook type PC, and may be an electronic device such as a desktop type PC, a tablet terminal, or a smartphone.

The information processing device 3 according to the present embodiment is connected to the projector 2 via an ad-hoc network 4 or an infrastructure network 5. Note that in the present embodiment, connection to the projector 2 means a connection so that the image data can be transmitted to the projector 2.

The ad-hoc network 4 is a network in which wireless communication devices directly communicate with each other. The ad-hoc network 4 is a network of a smaller scale than the infrastructure network 5. In the present embodiment, the ad-hoc network 4 is constructed by the projector 2 functioning as an access point.

The infrastructure network 5 is a network in which wireless communication devices communicate with each other via the access points. The infrastructure network 5 is a larger scale network compared to the ad-hoc network 4. Note that in the present embodiment, a wireless network is exemplified as the infrastructure network 5, but the infrastructure network 5 may be a wired network.

FIG. 1 illustrates two projectors 2.

The projector 2A is the projector 2 that can be connected via the ad-hoc network 4. The projector 2A is not connected to the infrastructure network 5 to which the information processing device 3 is connected. Note that the projector 2A may be connected to an infrastructure network different from the infrastructure network 5 to which the information processing device 3 is connected. The projector 2A is the projector 2A itself functions as the access point. The projector 2A constructs an ad-hoc network 4A of Service Set Identifier (SSID) according to a predetermined rule. The SSID of the ad-hoc network 4A constructed by the projector 2A includes identification information J2 of the projector 2A. An example of the identification information J2 of the projector 2 is a projector name representing the name of the projector 2.

The projector 2A is an example of a “first display device”.

A projector 2B is the projector 2 that can be connected via an ad-hoc network 4B. The projector 2B is connected to the infrastructure network 5 to which the information processing device 3 is connected. The projector 2B itself functions as the access point. The projector 2B constructs the SSID ad-hoc network 4B according to a predetermined rule. The SSID of the ad-hoc network 4B constructed by the projector 2B includes the identification information J2 of the projector 2B.

The projector 2B is an example of a “second display device”.

### 2. Configurations of Projector and Information Processing Device

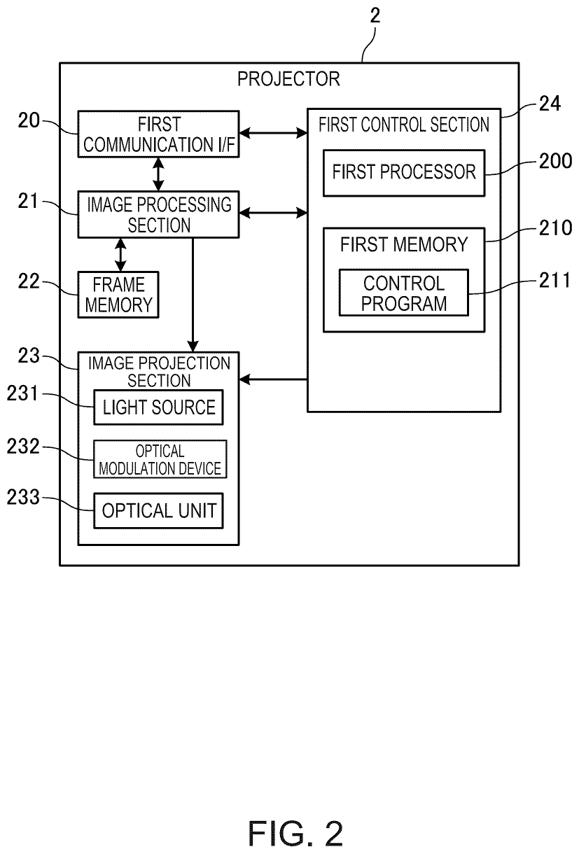

Next, the configuration of the projector 2 will be described with reference to FIG. 2.

FIG. 2 is a block diagram illustrating the configuration of the projector 2.

The projector 2 includes a first communication interface 20, an image processing section 21, a frame memory 22, an image projection section 23, and a first control section 24. Hereinafter, interface is abbreviated as I/F.

The first communication I/F 20 includes, for example, a wired interface that has connection terminals such as a Universal Serial Bus (USB) connector and an Ethernet connector, and that has an interface circuit. The Ethernet is a registered trademark.

The first communication I/F 20 includes a wireless interface having an interface circuit or the like conforming to the Wi-Fi standard, for example. The Wi-Fi is a registered trademark.

In the case in which the projector 2 functions as the access point, the first communication I/F 20 includes the wireless interface having the interface circuit or the like conforming to the Wi-Fi Direct standard, for example. The Wi-Fi Direct is a registered trademark.

The frame memory 22 is connected to the image processing section 21. The frame memory 22 includes a plurality of banks. Each bank has a storage capacity capable of writing a display image of one frame. The frame memory 22 is configured by, for example, a Synchronous Dynamic RAM (SDRAM). The image processing section 21 develops the image input from the first communication I/F 20 in the frame memory 22.

The image processing section 21 performs image processes on the image developed in the frame memory 22. The image process performed by the image processing section 21 includes, for example, a resolution conversion process or a resizing process, a distortion aberration correction, a shape correction process, a digital zoom process, an adjustment of the color tone and brightness of an image, and the like. The image processing section 21 executes the process designated by the first control section 24, and performs the process using a parameter input from the first control section 24 as necessary. The image processing section 21 can of course execute a combination of a plurality of image processes among the above.

The image processing section 21 and the frame memory 22 are each configured by, for example, an integrated circuit. The integrated circuit includes a Large Scale Integration (LSI), an Application Specific Integrated Circuit (ASIC), a Programmable Logic Device (PLD), a Field-Programmable Gate Array (FPGA), a System-on-a-Chip (SoC), and the like. An analog circuit may be included in a part of the configuration of the integrated circuit, or the first control section 24 and the integrated circuit may be combined.

The image projection section 23 includes a light source 231, a light modulation device 232, and an optical unit 233.

The light source 231 includes a discharge type light source lamp such as an ultra-high pressure mercury lamp or a metal halide lamp, or a solid-state light source such as a light emitting diode or a semiconductor laser. The light emitted from the light source 231 enters the light modulation device 232.

The light modulation device 232 includes a transmissive liquid crystal panel in which liquid crystal is sealed between a pair of transparent substrates as a light modulation element that modulates the light emitted from the light source 231. The liquid crystal panel is not illustrated. The liquid crystal panel includes a panel region including a plurality of pixels arranged in a matrix. The light modulation device 232 applies a drive voltage corresponding to the image input from the image processing section 21 to each pixel in the panel region to change the light transmittance of each pixel to a transmittance corresponding to the display image. The light emitted from the light source 231 is transmitted through the liquid crystal panel, whereby the light is modulated, and the image light corresponding to the image to be projected is generated.

The light modulation element included in the light modulation device 232 is not limited to the transmissive liquid crystal panel, and may be, for example, a reflective liquid crystal panel or a Digital Micromirror Device (DMD).

The optical unit 233 includes a projection lens (not illustrated) and the like, and emits the image light modulated by the light modulation device 232.

The first control section 24 is a computer device including a first processor 200 such as a Central Processing Unit (CPU) or a Micro Processing Unit (MPU), and a first memory 210.

The first memory 210 is a storage device that stores programs and data. The first memory 210 stores a control program 211, data processed by the first processor 200, and the like. The first memory 210 has a non-volatile storage region. The first memory 210 includes a volatile storage region and constitutes a work area of the first processor 200. The first memory 210 is configured by, for example, a Read Only Memory (ROM) or a Random Access Memory (RAM).

The first processor 200 executes the control program 211 stored in the first memory 210 to cause the image processing section 21 and the image projection section 23 to project the image supplied from the information processing device 3 on the projection surface.

The first processor 200 executes the control program 211 stored in the first memory 210, and thereby, when a device search packet (to be described later) is received by the first communication I/F 20, transmits a response packet by the first communication I/F 20. The response packet includes the identification information J2 of the projector 2.

When the projector 2 functions as the access point, the first processor 200 executes the control program 211 stored in the first memory 210, thereby constructing the ad-hoc network 4 by the first communication I/F 20.

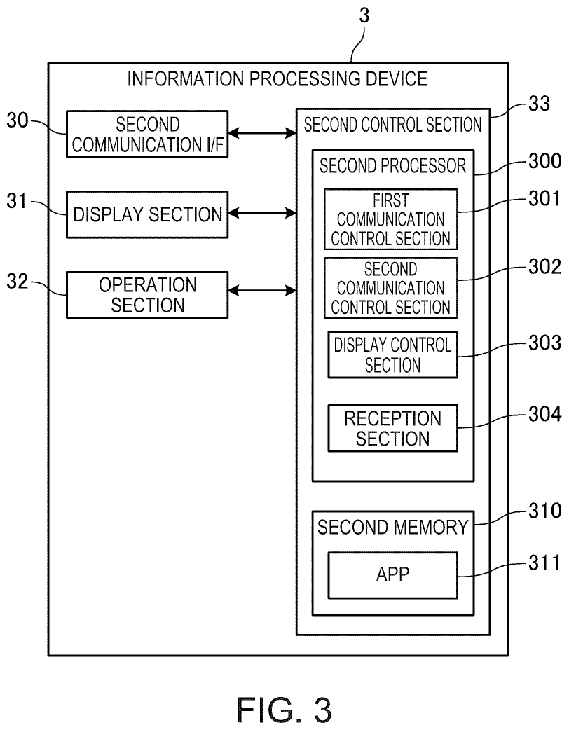

Next, a configuration of the information processing device 3 will be described with reference to FIG. 3.

FIG. 3 is a block diagram illustrating the configuration of the information processing device 3.

The information processing device 3 includes a second communication I/F 30, a display section 31, an operation section 32, and a second control section 33.

The second communication I/F 30 includes, for example, a wired interface that has connection terminals such as a USB connector and a Ethernet connector, and that has an interface circuit.

The second communication I/F 30 includes a wireless interface having an interface circuit or the like conforming to the Wi-Fi standard, for example.

The second communication I/F 30 includes the wireless interface having the interface circuit or the like conforming to the Wi-Fi Direct standard, for example.

The display section 31 includes a display such as a liquid crystal display or an Electro Luminescence (organic EL) display.

The operation section 32 includes an input device such as a mouse or a keyboard, and receives an operation of the user. The operation section 32 outputs an operation signal corresponding to the received operation to the second control section 33.

The second control section 33 is a computer device including a second processor 300 such as a CPU or an MPU, and a second memory 310.

The second processor 300 is an example of a “processor”.

The second memory 310 is a storage device that stores programs and data. The second memory 310 stores an application program 311, data processed by the second processor 300, and the like. The second memory 310 has a non-volatile storage region. The second memory 310 includes a volatile storage region and constitutes a work area of the second processor 300. The second memory 310 is configured by, for example, a ROM or a RAM. Hereinafter, the application program 311 is referred to as the APP 311.

The APP 311 is an example of a “program”.

By reading and executing the APP 311 stored in the second memory 310, the second processor 300 functions as a first communication control section 301, a second communication control section 302, a display control section 303, and a reception section 304.

The first communication control section 301 performs a network scan by the second communication I/F 30. The first communication control section 301 receives a SSID signal transmitted from the projector 2 by the network scan, and detects the SSID indicated by the SSID signal. By this, the first communication control section 301 detects the projector 2 functioning as the access point. When the first communication control section 301 detects the SSID, it acquires the identification information J2 of the projector 2 from the SSID for each of the detected SSID.

When the first communication control section 301 is connected to the projector 2 via the ad-hoc network 4, it communicates with the projector 2 via the ad-hoc network 4 by the second communication I/F 30.

The SSID signal is an example of a “signal”.

The second communication control section 302 broadcasts a device search packet conforming to the communication protocols of the projector 2 to the infrastructure network 5 by the second communication I/F 30. When the device search packet is broadcast, the second communication control section 302 receives a response packet to the device search packet for a certain period of time after the broadcast. When the second communication control section 302 receives the response packet, it acquires the identification information J2 of the projector 2 from the received response packet. By this, the second communication control section 302 detects the projector 2 connected to the infrastructure network 5.

When the second communication control section 302 is connected to the projector 2 via the infrastructure network 5, it communicates with the projector 2 via the infrastructure network 5 by the second communication I/F 30.

The second communication control section 302 communicates with devices other than the projector 2 via the infrastructure network 5 by the second communication I/F 30. Examples of the device other than the projector 2 include a device that holds data downloaded by the information processing device 3.

The display control section 303 displays a list G1 of the connectable projectors 2 by the display section 31.

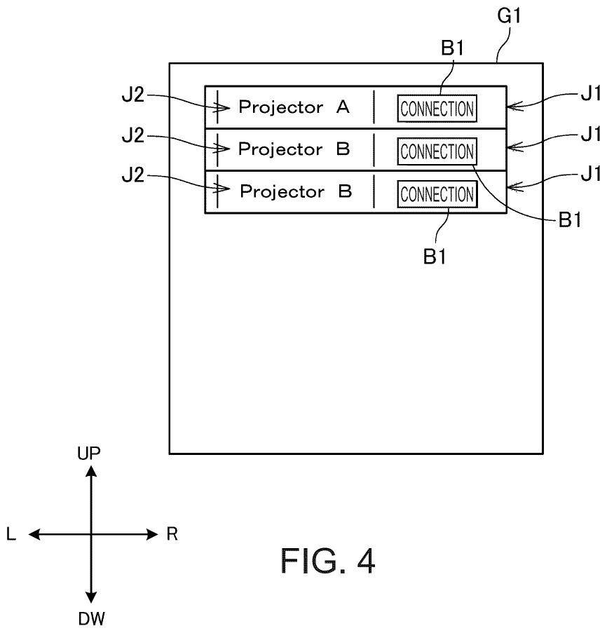

FIG. 4 is a diagram illustrating an example of the list G1.

In FIG. 4, the direction going up in the drawing is indicated by a symbol UP as an upward direction, the direction going down in the drawing is indicated by a symbol DW as a downward direction, the direction going left in the drawing is indicated by a symbol L as a leftward direction, and the direction going right in the drawing is indicated by a symbol R as a rightward direction. The four directions of up, down, left, and right correspond to the four directions of up, down, left, and right in a state where the display of the information processing device 3 is viewed.

The list G1 is a screen for displaying a list of the projectors 2 detected by the first communication control section 301 and the projectors 2 detected by the second communication control section 302. The list G1 displays projector information J1 for each projector 2.

The projector information J1 includes the identification information J2 of the projector 2. In FIG. 4, each of “Projector A” and “Projector B” is the identification information J2 of the projector 2. In FIG. 4, “Projector A” is the identification information J2 of the projector 2A. In FIG. 4, “Projector B” is the identification information J2 of the projector 2B.

Note that in FIG. 4, two pieces of projector information J1 including “Projector B” are displayed. This is because the information processing device 3 detects the projector 2B in which the first communication control section 301 and the second communication control section 302 are the same.

The projector information J1 includes a connection button B1. The connection button B1 is a software button that receives a first operation from the user. The first operation is an operation of requesting a connection to the projector 2. More specifically, the first operation is an operation of selecting the identification information J2 of the projector 2 to which the information processing device 3 transmits the image data in the list G1.

When the projector 2 not connected to the infrastructure network 5 is selected from the list G1 by the first operation, the display control section 303 uses the display section 31 to display a notification screen G2 so as to be superimposed on the list G1.

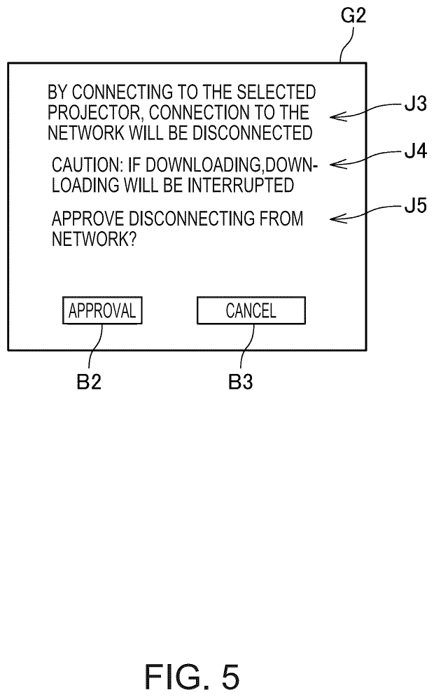

FIG. 5 is a diagram illustrating an example of the notification screen G2.

The notification screen G2 is a screen for notifying that the connection with the infrastructure network 5 will be disconnected.

The notification screen G2 includes a first information J3, a second information J4, and a third information J5.

The first information J3 is information indicating that the connection with the infrastructure network 5 is to be disconnected. In FIG. 5, the text string “BY CONNECTING TO THE SELECTED PROJECTOR, CONNECTION TO THE NETWORK WILL BE DISCONNECTED” is the first information J3.

The second information J4 is information indicating that, if the information processing device 3 is downloading, downloading will to be interrupted. In FIG. 5, the character string is “CAUTION: IF DOWNLOADING, DOWNLOADING WILL BE INTERRUPTED”.

The third information J5 is information for inquiring whether or not to approve the disconnection from the infrastructure network 5. In FIG. 5, the third information J5 is a text string “APPROVE DISCONNECTING FROM NETWORK?”

The notification screen G2 includes an approval button B2 and a cancel button B3.

The approval button B2 is a software button that receives a second operation. The second operation is an operation of approving the disconnection of the connection with the infrastructure network 5.

The cancel button B3 is a software button that receives a third operation. The third operation is an operation not approving the disconnection from the infrastructure network 5.

Returning to the description of the functional sections of the second processor 300, the reception section 304 receives various operations from the user via the operation section 32. The reception section 304 receives the first operation via the connection button B1 in the list G1 displayed by the display control section 303. The reception section 304 receives the second operation via the approval button B2 on the notification screen G2 displayed by the display control section 303. The reception section 304 receives a third operation via the cancel button B3 on the notification screen G2 displayed by the display control section 303.

### 3. Operation of Information Processing Device

Next, an operation of the information processing device 3 in the present embodiment will be described.

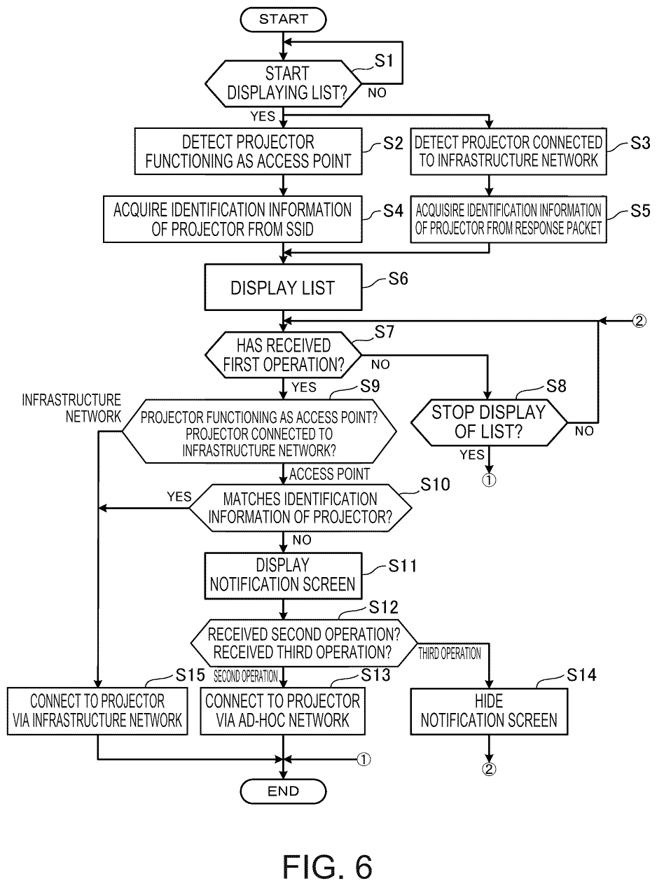

FIG. 6 is a flowchart illustrating the operation of the information processing device 3.

The display control section 303 determines whether or not to start displaying the list G1 (step S1). For example, when the reception section 304 receives an instruction to start displaying the list G1, the display control section 303 determines to start displaying the list G1. For example, when the APP 311 has started, the display control section 303 determines to start displaying the list G1.

When it is determined that the display of the list G1 is started (step S1: YES), the first communication control section 301 detects the projector 2 functioning as access point (step S2). More specifically, in step S2, the first communication control section 301 starts network scanning to detect SSID according to a predetermined rule.

In the case in which it is determined that the display of the list G1 is started (step S1: YES), the second communication control section 302 detects the projector 2 connected to the infrastructure network 5 (step S3). More specifically, by broadcasting a device search packet, the second communication control section 302 starts receiving a response packet to the device search packet. Note that the detection of step S3 is performed in parallel with the detection of step S2.

When the SSID detection is completed, the first communication control section 301 acquires the identification information J2 of the projector 2 from the detected SSIDs for each of the detected SSIDs (step S4).

When a certain period of time elapses after the device search packet is broadcast, for each response packet that was received until the certain period of time elapsed, the second communication control section 302 acquires the identification information J2 of the projectors 2 from the response packets (step S5).

The display control section 303 uses the display section 31 to display the list G1, which includes the identification information J2 of the projectors 2 acquired in step S4 and the identification information J2 of the projectors 2 acquired in step S5 (step S6).

Next, the display control section 303 determines whether the reception section 304 has received the first operation (step S7). When the display control section 303 determines that the reception section 304 has not received the first operation (step S7: NO), it determines whether or not to stop the display of the list G1 (step S8). For example, when the reception section 304 receives an instruction to stop the display of the list G1, the display control section 303 determines to stop the display of the list G1.

When the display control section 303 determines to stop the display of the list G1 (step S8: YES), the second processor 300 ends the present process. On the other hand, when the display control section 303 determines not to stop the display of the list G1 (step S8: NO), the second processor 300 returns the process to step S7.

Returning to the description of step S7, when it is determined that the reception section 304 has received the first operation (step S7: YES), the display control section 303 determines whether the projector 2 selected by the first operation is a projector 2 functioning as an access point or a projector 2 connected to the infrastructure network 5 (step S9).

Note that the determination of the step S9 is performed based on whether the identification information J2 of the projector 2 corresponding to the connection button B1 that received the first operation is the identification information acquired by first communication control section 301 or identification information acquired by the second communication control section 302.

When the display control section 303 determines that the projector 2 functions as an access point (step S9: access point), it performs the process of step S10. That is, the display control section 303 determines whether or not the identification information J2 of projectors 2 acquired in step S5 includes the identification information J2 of a projector 2 that matches the identification information J2 of the projector 2 selected by the first operation (step S10).

When the display control section 303 determines that there is no matching identification information J2 of the projector 2 (step S10: NO), it displays the notification screen G2 on the display section 31 (step S11).

Next, the display control section 303 determines whether the reception section 304 has received the second operation or the third operation (step S12).

When the display control section 303 determines that the reception section 304 has received the second operation (step S12: second operation), the second processor 300 performs the process of step S14. That is, the first communication control section 301 connects the projector 2 selected by the first operation as the projector 2 to which the information processing device 3 transmits the image data via the ad-hoc network 4 (step S13).

On the other hand, when the display control section 303 determines that the reception section 304 has received the third operation (step S12: third operation), the display control section 303 stops display of the notification screen G2 (step S14).

Returning to the description of step S10, when the display control section 303 determines that there is identification information J2 of a projector 2 that matches the identification information J2 (step S10: YES), the second processor 300 executes the process of step S15. That is, the second communication control section 302 connects the projector 2 selected by the first operation as the projector 2 to which the information processing device 3 is to transmit image data via the infrastructure network 5 (step S15).

Returning to the description of step S9, when the display control section 303 determines that the projector 2 is connected to the infrastructure network 5 (step S9: infrastructure network), the second processor 300 executes the process of step S15.

The operation of FIG. 6 will be described in detail with reference to FIG. 1.

When the information processing device 3 receives an operation of requesting connection to the projector 2A in the list G1, it displays the notification screen G2. This is because the projector 2A is not connected to the infrastructure network 5, and a negative determination is made in step S10. When the information processing device 3 receives an operation of approving the disconnection from the infrastructure network 5 via the notification screen G2, the information processing device 3 connects to the projector 2A via the ad-hoc network 4A as the projector 2 to which image data is to be transmitted.

When the information processing device 3 receives an operation of requesting connection to the projector 2B in the list G1, it does not display the notification screen G2. This is because the projector 2B is connected to the infrastructure network 5, and the process is executed in the order of step S9 and S15, or in the order of step S10 and S15. In this case, the information processing device 3 is connected to the projector 2B via the infrastructure network 5 as the projector 2 to which image data is to be transmitted.

Next, the effects of the present embodiment will be described by exemplifying a case where the projection system 1 is used in an educational site.

In this usage scene, a case where the information processing device 3 used by a teacher is connected to the infrastructure network 5 is exemplified. In this usage scene, a case where the projector 2B used in a staff room is connected to the infrastructure network 5 is exemplified. In this usage scene, a case where the projector 2A is placed in a classroom where a class is held is exemplified.

When the teacher gives a class using the projector 2A in the classroom, the teacher connects the projector 2A and the information processing device 3 via the ad-hoc network 4. However, the teacher does not necessarily know that the projector 2A functions as an access point, that the information processing device 3 is connected to the infrastructure network 5, and that the connection to the infrastructure network 5 will be disconnected when the information processing device 3 is connected to the projector 2A. Therefore, if the projector 2A and the information processing device 3 are connected to each other without displaying the notification screen G2, then the teacher may fall into a state where the teacher cannot connect to the infrastructure network 5 although the reason is unknown. The teacher may fall into a state in which the data for the class downloaded via the infrastructure network 5 is not downloaded although the reason is unknown.

Therefore, in the present embodiment, the notification screen G2 is displayed when the projector 2A is connected, thereby notifying that the connection with the infrastructure network 5 is to be disconnected. In the present embodiment, when the disconnection of the connection with the infrastructure network 5 is approved, the projector 2A is connected via the ad-hoc network 4. By this, the teacher can grasp that the connection between the information processing device 3 and the infrastructure network 5 is to be disconnected, and then the information processing device 3 and the projector 2A can be connected to each other via the ad-hoc network 4. It is possible to prevent the teacher from falling into a state where the teacher cannot connect to the infrastructure network 5 for an unknown reason after the connection to the projector 2A. Further, since it is possible to increase the possibility that the information processing device 3 and the projector 2A are connected to each other after data for the class is downloaded, it is possible to reduce the possibility that the class does not progress due to the fact that the data cannot be downloaded from the infrastructure network 5.

Note that the operation of FIG. 6 is an operation when the information processing device 3 is to be connected to the infrastructure network 5. When the information processing device 3 is not connected to the infrastructure network 5, the information processing device 3 is connected to the projector 2, which functions as an access point, via the ad-hoc network 4 without displaying the notification screen G2.

### 4. Other Embodiments

The above described embodiments are preferred embodiments of the present disclosure. However, the present disclosure is not limited to the above described embodiments, and various modifications can be made without departing from the gist of the present disclosure.

In the embodiment described above, the projection system 1 is configured to include one projector 2 that is not connected to the infrastructure network 5. However, the projection system 1 may include a plurality of projectors 2 that are not connected to the infrastructure network 5.

In the embodiment described above, the projection system 1 is configured to include one projector 2 that is connected to the infrastructure network 5. However, the projection system 1 may include a plurality of projectors 2 that are connected to the infrastructure network 5.

In the embodiment described above, the projection system 1 includes one information processing device 3 that is connected to the infrastructure network 5. However, the projection system 1 may include a plurality of information processing devices 3 that are connected to the infrastructure network 5.

In the embodiments described above, the projector 2 is exemplified as the “display device”, but the “display device” is not limited to the projector 2, and may be a display device that includes a touch panel and can operate a display surface of the touch panel.

The functions of the first processor 200 and the second processor 300 may be realized by a plurality of processors or a semiconductor chip.

The sections of the projector 2 illustrated in FIG. 2 and the sections of the information processing device 3 illustrated in FIG. 3 indicate functional configurations, and there are no particular limitations on the specific mounting forms. That is, hardware individually corresponding to each functional unit does not necessarily need to be mounted, and a configuration in which a plurality of functions are realized by one processor executing a program may be adopted. In the above embodiment, a part of the functions realized by software may be realized by hardware, and a part of the functions realized by hardware may be realized by software. In addition, the specific detailed configuration of each of the other sections of the projector 2 and the information processing device 3 can also be arbitrarily changed without departing from the gist of the present disclosure.

The process units of the flowchart illustrated in FIG. 6 are obtained by dividing the process of the information processing device 3 according to main process contents for easy understanding, and the present disclosure is not limited by the way of dividing the process units or the names of the process units. It may be divided into many step units according to the process content. The process may be divided so that one step unit includes many processes. The order of the steps may be changed as appropriate within a range not interfere with the gist of the present disclosure.

In a case where the control method for the information processing device 3 described above is realized using the second processor 300, it is also possible to configure a program to be executed by the second processor 300 in the form of a recording medium or a transmission medium that transmits the program. That is, the APP 311 can be realized in a state of being recorded on a portable information recording medium. Examples of the information recording medium include a magnetic recording medium such as a hard disk, an optical recording medium such as a CD, and a semiconductor storage device such as a Universal Serial Bus (USB) memory or a Solid State Drive (SSD), but other recording media can also be used.

### 5. Summary of Present Disclosure

Hereinafter, a summary of the present disclosure is appended.

### Appendix 1

A control method for an information processing device connected to an infrastructure network, the control method including receiving an operation of requesting connection with a first display device that is not connected to the infrastructure network; when the operation of requesting connection is received, notifying that connection with the infrastructure network is to be disconnected; receiving an operation of approving disconnection from the infrastructure network; and when the operation of approving is received, connecting, via an ad-hoc network, the information processing device to the first display device as a display device to which image data is to be transmitted.

By this, the user can grasp that the connection between the information processing device and the infrastructure network is to be disconnected before it is connected to the display device that is not connected to the infrastructure network. Therefore, the information processing device can be connected to the display device that is not connected to the infrastructure network via the ad-hoc network in a state where the user grasps that the connection between the information processing device and the infrastructure network is to be disconnected.

### Appendix 2

The control method of the information processing device according to the Appendix 1, further including acquiring identification information of the first display device from a signal transmitted by the first display device and acquiring identification information of a second display device connected to the infrastructure network via the infrastructure network, wherein the notifying is to notify that connection with the infrastructure network is to be disconnected if the identification information of the first display device and the identification information of the second display device do not match.

By this, after it is confirmed that the display device that was requested to be connected to is not connected to the infrastructure network, it is possible to notify that the connection with the infrastructure network will be disconnected. Therefore, the user can be correctly notified that the connection with the infrastructure network is to be disconnected.

### Appendix 3

The control method of the information processing device according to the Appendix 1 or the Appendix 2, further including acquiring identification information of the first display device from a signal transmitted by the first display device; acquiring identification information of a second display device connected to the infrastructure network via the infrastructure network; and displaying a list including identification information of the first display device and identification information of the second display device, wherein the operation of requesting connection is an operation of selecting the identification information of the first display device from the list.

This enables the user to connect to the display device selected by the user via the ad-hoc network. Therefore, the user can connect to a desired display device via the ad-hoc network, and thus convenience in connection to the display device can be improved.

### Appendix 4

A display system includes a first display device that is not connected to an infrastructure network and an information processing device connected to the infrastructure network, wherein the information processing device receives an operation for requesting connection with the first display device, notifies that connection with the infrastructure network is to be disconnected when the operation of requesting connection is received, receives an operation of approving disconnection from the infrastructure network, and when the operation of approving is received, connects, via an ad-hoc network, the information processing device to the first display device as a display device to which the image data is to be transmitted.

This brings about an effect similar to that of the control method of an information processing device according to the Appendix 1.

### Appendix 5

A program causes a processor of an information processing device connected to an infrastructure network to receive an operation for requesting connection with a first display device that is not connected to the infrastructure network, notify that connection with the infrastructure network is to be disconnected when the operation of requesting connection is received, receive an operation of approving disconnection from the infrastructure network, and when the operation of approving is received, connect the information processing device to the first display device via an ad-hoc network as a display device to which image data is to be transmitted.

This brings about an effect similar to that of the control method of an information processing device according to the Appendix 1.

What is claimed is:

1. A control method for an information processing device connected to an infrastructure network, the control method comprising:
receiving an operation of requesting connection with a first display device that is not connected to the infrastructure network;
when the operation of requesting connection is received, notifying that connection with the infrastructure network is to be disconnected;
receiving an operation of approving disconnection from the infrastructure network; and
when the operation of approving is received, connecting, via an ad-hoc network, the information processing device to the first display device as a display device to which image data is to be transmitted.

2. The control method for the information processing device according to claim 1, further comprising:
acquiring identification information of the first display device from a signal transmitted by the first display device and acquiring identification information of a second display device connected to the infrastructure network via the infrastructure network, wherein
the notifying is
to notify that connection with the infrastructure network is to be disconnected if the identification information of the first display device and the identification information of the second display device do not match.

3. The control method for the information processing device according to claim 1, further comprising:
acquiring identification information of the first display device from a signal transmitted by the first display device;
acquiring identification information of a second display device connected to the infrastructure network via the infrastructure network; and
displaying a list including identification information of the first display device and identification information of the second display device, wherein
the operation of requesting connection is an operation of selecting the identification information of the first display device from the list.

4. A display system comprising:
a first display device that is not connected to an infrastructure network and
an information processing device connected to the infrastructure network, wherein the information processing device
receives an operation for requesting connection with the first display device,
notifies that connection with the infrastructure network is to be disconnected when the operation of requesting connection is received,
receives an operation of approving disconnection from the infrastructure network, and
when the operation of approving is received, connects, via an ad-hoc network, the information processing device to the first display device as a display device to which the image data is to be transmitted.

5. A non-transitory computer-readable storage medium storing a program,
the program causes a processor of an information processing device connected to an infrastructure network to
receive an operation for requesting connection with a first display device that is not connected to the infrastructure network,
notify that connection with the infrastructure network is to be disconnected when the operation of requesting connection is received,
receive an operation of approving disconnection from the infrastructure network, and
when the operation of approving is received, connect the information processing device to the first display device via an ad-hoc network as a display device to which image data is to be transmitted.
